(19) United States
(12) Patent Application Publication
(10) Pub. No.: US 2006/0123393 A1
(43) Pub. Date: Jun. 8, 2006

(54) User interface for network application

(76) Inventors: Brian Atkins, Fort Collins, CO (US); Hans Petersen, Fort Collins, CO (US); Christian Das, Fort Collins, CO (US)

Correspondence Address: AGILENT TECHNOLOGIES, INC.;INTELLECTUAL PROPERTY ADMINISTRATION, LEGAL DEPT., P.O. BOX 7599, M/S DL429, LOVELAND, CO, 80537-0599, US

(21) Appl. No.: 11/001,837

(22) Filed: Dec. 2, 2004

(51) Int. Cl. G06F 9/44

(52) U.S. Cl. 717/121

(57) ABSTRACT

A method and apparatus for programming a network application comprises representing available functions of the network application as a template node in a templates pane and configured functions of the network application a service node in a services pane. The method and apparatus permits a user to select one of the template nodes and presents a dialog box associated with the template node for population of the dialog box with configuration data. The method and apparatus then configures the network application according to the configuration data.

### BACKGROUND OF THE INVENTION

There are beneficial network applications that are less effective because of rudimentary user interfaces. Furthermore, there is an advantage to leveraging existing user interfaces for use with new applications rather then spend valuable engineering resources creating new ones. An example of a network application that benefits from leveraging an existing user interface is a CNS Performance Engine network application by Cisco Systems, Inc. used in conjunction with Cisco routers. With specific reference to FIG. 1 of the drawings, there is shown a conventional and illustrative network application 100, such as CNS Performance Engine, running on a host computer 102. The network application 100 is a software application that communicates with one or more devices 106 on a communications network 108 that are able to recognize and respond to the network application 100. All communications to and from the devices 106 are performed using the network application 100. In the case of the CNS Performance Engine network application configuration process, a user communicates with a web server 102 via a browser. A host that is running the CNS Performance Engine network application 100 may be the same processor that runs the web server or a different one on a communication network. The web server 102 responds to the user with an html form. The html form comprises a text box into which a user is to enter free-form text string information to configure the CNS Performance Engine network application 100. The text information must follow a specific syntax, must be in a specific order, and must contain specific values in order to properly configure the CNS Performance Engine network application 100. Accordingly, the user must be familiar with the specific network, the CNS Performance Engine components, the properties of the CNS Performance Engine components, and the correct syntax for proper configuration. The user then submits the text information, which sends the text information to the web server 102. In the specific case of the CNS Performance Engine network application, XML messages are sent to the network application 100 using a TIBCO messaging bus. The web server 102 receives the text information and relays the text to the CNS Performance Engine network application 100. The network application 100 uses the text information 104 to send configuration messages to one or more of the devices 106 that are configurable by the network application 100. In order to retrieve information from the devices 106, the network application 100 sends a query to the devices 106 that generate text based XML data that contains the requested information.

While the network application 100 provides valuable information and functions, use of the network application 100 is limited because of the less than intuitive user interface for configuration and status reporting of the devices 100. Submission and retrieval of text based XML information to perform configuration and to read device measurements and status must be done using a specific format and is, therefore, prone to error. There is a need, therefore, for an improved user interface for the network application. It is further beneficial to leverage an existing user interface for use with the network application.

U.S. Pat. No. 6,336,138 B1 to Caswell et al. entitled “Template Driven Approach For Generating Models on Network Services” filed Aug. 25, 1998 (herein “the Caswell patent”) and U.S. Pat. No. 6,182,136 B1 to Ramanathan et al. entitled “Automated Service Elements Discovery Using Core Service Specific Discovery Templates” filed Sep. 8, 1998 (herein “the Ramanathan patent”) disclose a service model and discovery methods for use in network applications that has an intuitive user interface for network applications. In addition, the information available from the Cisco routers is useful in the service model application. The process of modeling a service within a network environment includes forming a service model template that is not specific to the network environment, but identifies anticipated network elements and network services that cooperate to enable the selected service. The service model, however, is implemented in service model specific language and configuration methods.

It is desirable, therefore, for the user interface used in the template driven service model disclosed in the patents to Caswell and Ramanathan to be adaptable to other network applications. It is further desirable to integrate other network applications into the service model for use of information from the network application within the service model.

### BRIEF DESCRIPTION OF THE DRAWINGS

An understanding of the present invention can be gained from the following detailed description of the invention, taken in conjunction with the accompanying drawings of which:

FIG. 1 is a graphical representation of a network application having a text-based user interface illustrated as a process running on a host computer and communicating with a number of network devices.

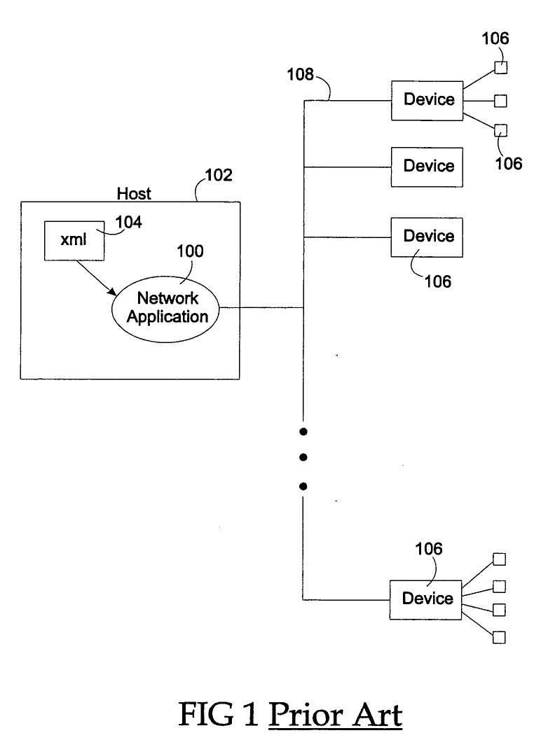

FIG. 2 is a graphical representation of processes and process communications with information to implement an apparatus and method according to the present teachings.

FIG. 3 is a more detailed graphical representation of the discovery engine shown in FIG. 2.

FIG. 4 is a flow chart of the discovery engine process in an embodiment of a user interface according to the present teachings.

FIG. 5 is an illustrative view of an administrative console display according to the present teachings.

FIG. 6 is a flow chart representing a network application component configuration process.

FIG. 7 is a representative dialog box used as part of a network application component configuration process.

FIG. 8 is a flow chart representing a more detailed view of a portion of the flow represented in FIG. 6.

FIG. 9 is a block diagram of relevant elements of an embodiment of a system according to the present teachings.

FIG. 10 is a flow chart of a process according to the present teachings.

### DETAILED DESCRIPTION

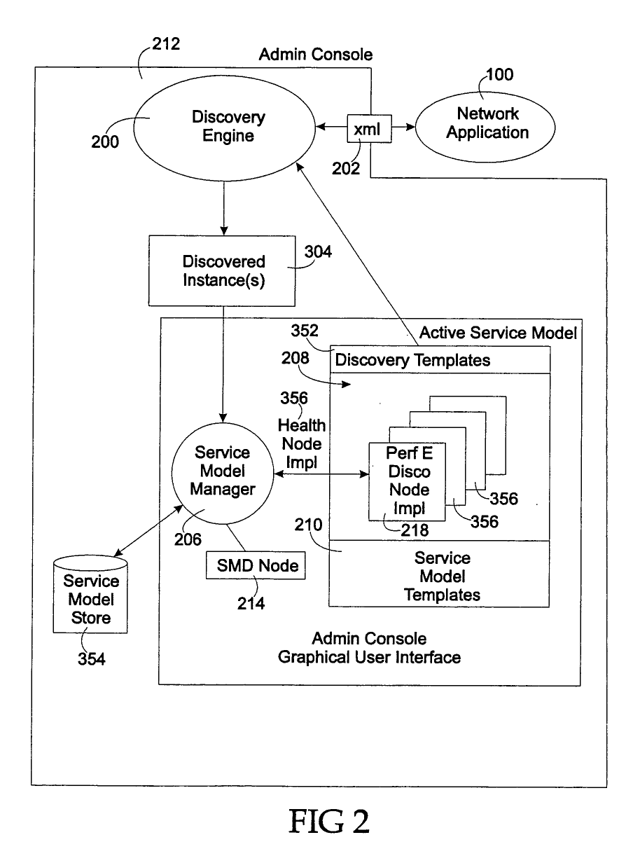

With specific reference to FIG. 2 of the drawings, there is shown a graphical representation of a portion of the service model disclosed in the Caswell and Ramanathan patents that is used to provide a user interface for a network application 100 such as the CNS Performance Engine by Cisco Systems, Inc. The teachings of both the Caswell and Ramanathan patents that are cited in the Background of this document are hereby incorporated by reference. The present disclosure teaches adaptations of certain portions of the conventional service model to integrate the CNS Performance Engine network application 100 into a common laser interface with the service model without disturbing the function of the conventional service model. Certain specific adaptations are unique to the CNS Performance Engine network application, but the framework for integrating the service model with a network application that is not already part of the service model may be applied to other network applications. The portion of the conventional service model discussed herein is referred to as an administrative console 212. New elements are added to the administrative console 212 that work in conjunction with the conventional service model to communicate and configure the network application 100. One of ordinary skill in the art with benefit of the present teachings is able to adapt any network application 100 to the service model user interface. Implementation of the user interface that is the subject of the present teachings is described with respect to adaptations made to the conventional service model disclosed in the Caswell and Ramanathan patents for application to the CNS Performance Engine network application 100 by Cisco Systems, Inc.

The user interface uses a discovery engine 200 portion of the conventional service model as part of the integration between the service model and the network application 100. The discovery engine 200 performs initialization of the user interface for the network application 100 by requesting a current status of the network application 100 and updating the user interface to reflect the current status. The discovery engine 200 runs on a conventional computer or other processing element that communicates with the network application 100 and reads XML data 202 that is created by the network application 100 in response to the status request. The discovery engine 200 utilizes a portion of the active service model 208, which is a discovery template 352. The discovery template 352 is applicable to the network application 100, is written using conventional SmartFrog syntax, and is consistent with the conventional discovery template format. The discovery template 352 provides information to the discovery engine 200 as to which discovery engine to execute. During the discovery process, the network application 100 returns a subset of the available attributes in an XML format 202 over the network using a proprietary syntax in response to the status request.

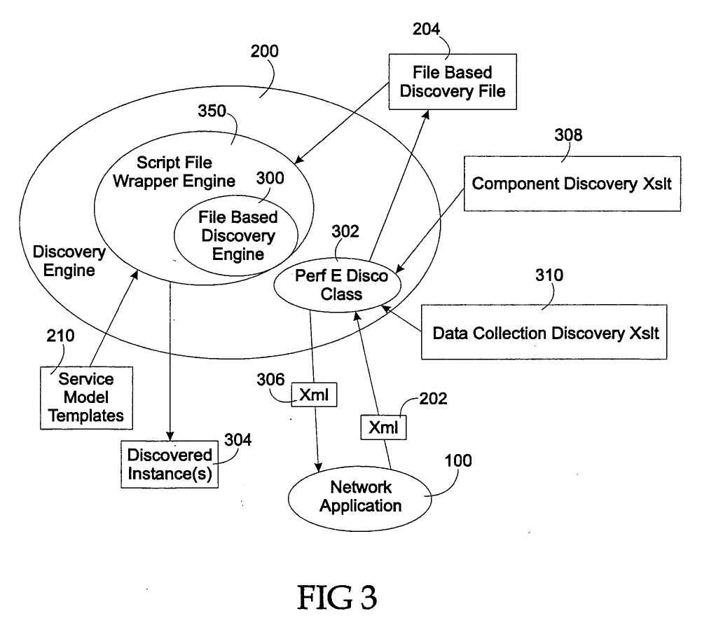

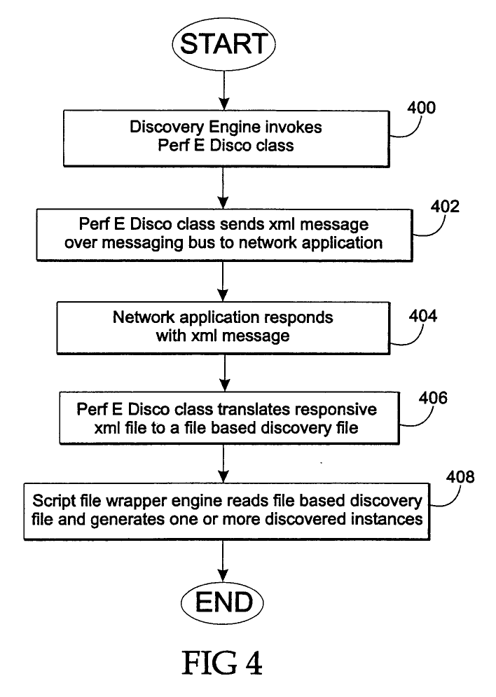

With specific reference to FIGS. 3 and 4 of the drawings, there is shown a more detailed view of the discovery engine 200 and process flow of the discovery engine 200 used in an embodiment according to the present teachings. The conventional service model comprises the discovery engine 200 with multiple possibilities for performance of network discovery as disclosed in the Ramanathan patent. The portion of the discovery engine 200 that is used to implement the user interface according to the present teachings comprises a file based discovery engine 300 module within the conventional discovery engine 200. The file based discovery engine 300 is extended by a script file wrapper engine 350 to accommodate the conventional file based discovery in addition to the discovery of the network application components. The discovery engine 200 also includes a PerfEDisco class 302. When the discovery engine 200 is invoked, the script file wrapper engine 350 invokes 400 the PerfEDisco class 302. Conventionally, a processor communicates with the CNS Performance Engine network application 100 over a TIBCO Rendezvous messaging bus. The specific communications bus is not important, but because the CNS Performance Engine process is conventionally configured to communicate over it, it is most efficient for the PerfEDisco class 302 to use it in its communications with the network application 100. With respect to the CNS Performance Engine network application 100, the PerfEDisco class 302 is specific and tailored to the network application 100 and acts as a part of a translation mechanism between the network application and the service model.

In the present embodiment, the PerfEDisco class 302 is implemented in JAVA. The PerfEDisco class 302 is a utility used by the script file wrapper engine 350 to communicate with the network application 100. The PerfEDisco class 302 sends 402 a status request 306 in the form of an XML string over the TIBCO messaging bus to the network application 100. The network application 100 receives the status request 306 and interprets it as requesting a configuration status update. The network application 100 responds 404 with a responsive XML message 202 that contains text representing the current configuration of the network application 100 and the devices 106 to which the network application 100 communicates. The PerfEDisco class 302 reads 406 the responsive XML message 202 and translates 406 the configuration status data into file based discovery syntax, which in a specific embodiment is a subset of the SmartFrog language. The translation by the PerfEDisco class 302 is performed in conjunction with a component discovery XSLT file 308. The resulting translation is stored as a file based discovery file 204 using a conventional file based discovery format used for file based discovery of network components. The script file wrapper engine 350 recognizes a presence of the file based discovery file 204. The script file wrapper engine 350, which is an extension of the file based discovery engine 300 and uses the same interface, reads and interprets 408 the file based discovery file 204 and uses the file based discovery file 204 in conjunction with the service model templates 210 to generate one or more discovered instances 304. As each discovered instance 304 is generated, it is available to the service model manager 206 for insertion into the active service model 208. As each instance is added, the service model manager 208 processes the next discovered instance 204. When all discovered instances 204 from the file based discovery file 204 are processed by the service model manager 206, the initial network application configuration is available as the active service model 208 to the administrative console 212.

A further adaptation made to the conventional service model as part of the discovery process of the network application status is establishment of a hidden node 218 of a PerfEDiscoNodeImpl class. There is one instance of the PerfEDiscoNodeImpl class 218 in the active service model 208. It is instantiated at start up of the administrative console 212, it is always present and it is unique to the network application 100. The PerfEDiscoNodeImpl class 218 extends a HealthNodeImpl class that is part of the conventional service model. The HealthNodeImpl class is chosen because it propagates node health status through the active service model tree in the conventional service model. Because it is desirable to maintain the propagation characteristic in a context of the network application 100, it is efficient to use the conventionally defined HealthNodeImpl class. The PerfEDiscoNodeImpl class 218 overrides an sfdeploy( ) method as defined in the HealthNodeImpl class with a new method that communicates with the network application 100. Upon start up of the administrative console 212, the service model manager 206 reads a service model store 354 and instantiates all of the nodes found therein to create the active service model 208. Each instantiated node is represented as a HealthNodeImpl instance 356 in the active service model 208.

Prior to system start-up, the current configuration of the service model is stored on external media in a service model store 254. The service model store 354 contains a SmartFrog description of the nodes in the active service model 208. When reading a service model store 354 into the administrative console 212, an sfClass SmartFrog attribute in the service model template 210 is used to determine which JAVA class should be instantiated for every node in the active service model 208. Instantiation of all nodes in the active service model 208 includes instantiation of the PerfEDiscoNodeImpl class 218 hidden node. Within the PerfEDiscoNodeImpl SmartFrog description in the service model store 354, the sfClass SmartFrog attribute is found who's associated value is a dotted JAVA path to the PerfEDiscoNodeImpl class 218. As a result, a PerfEDiscoNodeImpl node 218 is instantiated as a child node of domain node 512 and, while hidden from a user's view in the administrative console user interface 216, can affect all other nodes in the active service model 208. When the PerfEDiscoNodeImpl class is instantiated by the service model manager 206, the service model manager 206 calls an sfDeploy( ) method defined within the PerfEDiscoNodeImpl class 218. Within the sfDeploy( ) method, a new thread is created that is responsible for running the script file wrapper engine 350. The new sfDeploy( ) thread blocks until the administrative console 216 has completely read the entire active service model 208 into memory. At this point, the thread responsible for running the script file wrapper engine 350 is released and the responsive XML file 202 is read from the network application 100.

The sfDeploy( ) method as redefined in the PerfEDiscoNodeImpl class, first establishes a connection to the network application 100. In the specific embodiment where the network application 100 is the Cisco CNS Performance Engine, the established connection is over the TIBCO bus. The active service model 208 is cleared and the PerfEDisco class 302 is instantiated. The PerfEDisco class 302 queries the network application 100 requesting its current status and receives the responsive XML message 202 from the network application 100. In the specific embodiment of the Cisco CNS Performance Engine network application 100, the PerfEDisco class makes the query by sending an appropriate XML message requesting a current configuration status over the TIBCO bus. Similarly, the PerfEDisco class 302 receives the responsive XML message 202 from the CNS Performance Engine network application 100. The PerfEDisco class 302 then uses the responsive XML string message 202 together with the component discovery XSLT file 308—to translate the XML string 202 sent in response to a configuration status query to a format suitable for use by the discovery engine 200. The suitable format is the file based discovery format, which is a subset of the SmartFrog format. The component discovery XSLT file 308 uses an XPath query language available as a library for the JAVA language to define a set of rules for parsing the XML string 202. The XSLT rules identify attributes within the XML string 202 that assists the PerfEDisco class 302 in parsing the XML file 202 and building the SmartFrog equivalent of the XML responsive message 202 from the network application 100. The resulting translation of the responsive XML string 202 is written in a subset of the file based discovery format and stored as the file based discovery file 204. The script file wrapper engine 350 reads the file based discovery file 204, and with the service model templates 210 creates the one or more discovered instances 304. As each discovered instance 304 is created, the service model manager 206 accesses the discovered instance 304 and creates one HealthNodeImpl instance 356 for storage in the active service model 208 as one or more nodes that describe the related network application component. The service model manager 206 process each discovered instance 304 until all of them are part of the active service model 208 as HealthNodeImpl instances 356.

With reference to FIG. 2 of the drawings, after the active service model 208 is established based on the service model store 354 and the one or more discovered instances from the network application, an administrative console graphical user interface (GUI) 216, by having access to the active service model 208, is able to represent the current network application configuration status in a hierarchical tree. The active service model 208 also contains service model templates 210 to which the service model manager 206 has access. The service model templates 210 are written using the SmartFrog syntax. The service model templates 210 are created specifically to describe a respective number of configurable component types within the network application 100. Other service model templates 210 present in the active service model 208 describe other configurable elements of the service model not related to the network application 100. In order to implement the user interface according to the present teachings for any network application 100, therefore, it is necessary to understand the configurable components of the network application 100 and to organize, abstract, and represent them using the SmartFrog syntax in the service model template 210. The SmartFrog syntax permits categorizing the network application components. Categories can have sub-categories as considered appropriate by a creator of the service model template 210 to further organize and define the network application components. User documentation that is typically available to network application users is helpful in order to properly abstract, organize and prepare the service model template 210.

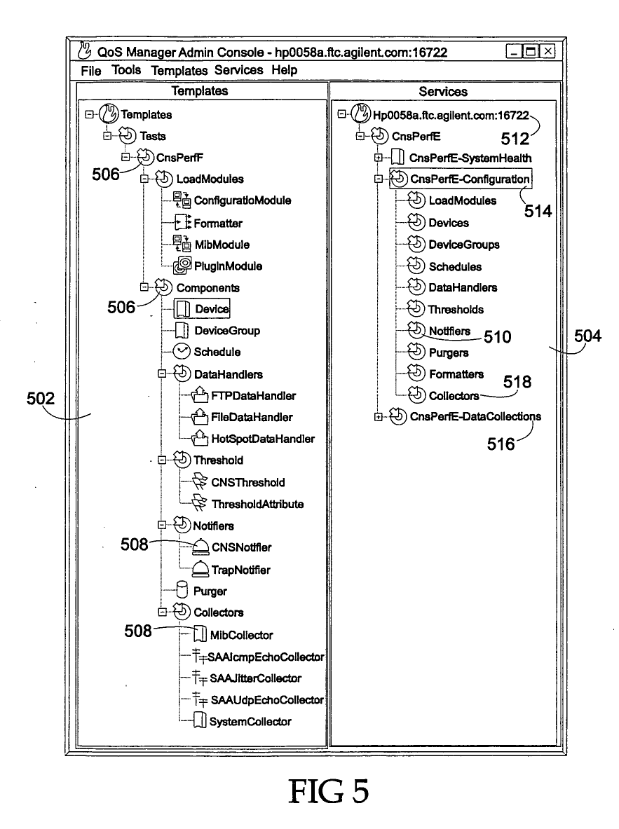

The administrative console 212 runs on a JAVA Virtual Machine. It reads the service model template 210 stored in the SmartFrog syntax for the network application 100 and provides to a user, a display of configurable components of the network application 100 in a hierarchical representation as defined in the service model templates 210. With specific reference to FIG. 5 of the drawings, there is shown an illustration of the hierarchical display provided by the administrative console GUI 216. The administrative console GUI display is divided into two major portions; a templates pane 502 and a services pane 504. The templates pane 502 is a graphical representation of the components of the network application 100 that are defined in the service model template 210 and captured in the SmartFrog syntax. The hierarchical representation of the templates pane 502 follows a conventional tree display similar to that used in the Microsoft® Windows Explorer software. Each component defined for the network application 100 is represented as one or more nodes 506 or 508 in the templates pane 502. Each node is either a tree node 506 or a leaf node 508. The tree nodes 506 are hierarchical parent nodes of child nodes. They are expandable and contain other tree or leaf nodes 506, 508. Leaf nodes 508 contain data and are not expandable. The type and placement for each node 506, 508 in the hierarchy that is defined for the network application 100 is provided to the administrative console 212 by the service model template 210. The service model template 210 may also provide default values for configurable properties of each component represented as a node 506, 508.

The visible HealthNodeImpl instances 356 of the active service model 208 are represented to the user as one or more related nodes in the services pane 504 of the administrative console 502. A node is instantiated in the services pane 504 under one or more container nodes 510. The container nodes 510 are also defined in the services model template 210. They comprise node classes into which a specific instance of a node from the templates pane 502 may be created. In this way, the container nodes control where certain types of nodes may be placed in the active service model hierarchy and provide an error message if a user attempts to place a node of an improper type in one of the container nodes 510. The container nodes 510 define certain functions that are performed for that particular class of node. A user configures a network application component by instantiating a node in the services pane 504. From a user point of view, node instantiation is performed using a conventional “drag&drop” type of operation from the templates pane 502 to the services pane 504.

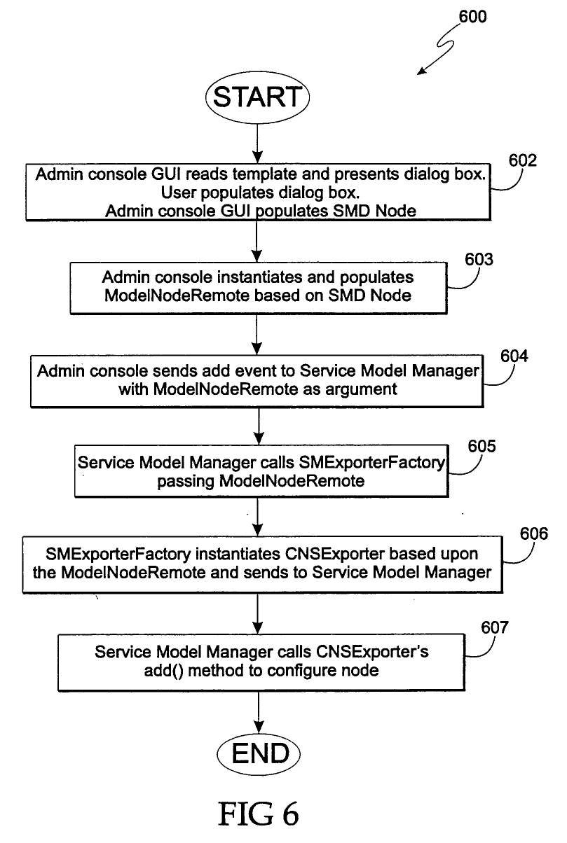

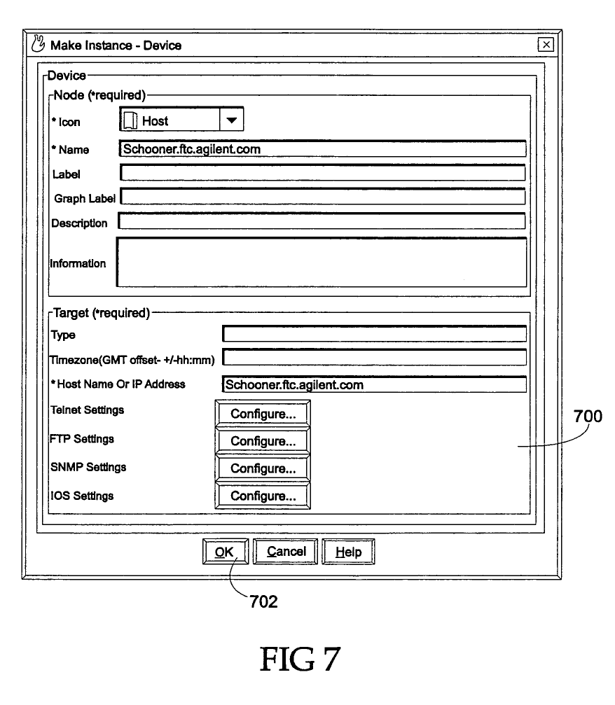

With specific reference to FIGS. 6 and 7 of the drawings, there is shown a graphical illustration of a process flow for the drag&drop 600 operation for network application component configuration. In FIG. 6, a user selects one of the leaf nodes 508 in the templates pane 502, drags and drops it into a specific container node 510 location in the hierarchy displayed in the services pane 504. The node that is selected by a user is hereinafter referred to as “the referenced node”. The drag&drop operation causes the administrative console 212 to read 602 the portion of the service model template 210 that is relevant to the referenced node. Upon obtaining information about the network application component to be configured from the service model template 210, the administrative console graphical user interface 216 creates a new instance of an SMDNode class. The SMDNode is a JAVA class defined in the administrative console 212. The SMDNode is an intermediate representation of the SmartFrog template description found in the service model templates 210. The administrative console GUI 216 populates the SMDNode instance 214 with information from a portion of the SmartFrog template that applies to the referenced node. The SMDNode instance 214 is used by the administrative console GUI 216 to create a conventional dialog box 700 that is specific to the referenced node for retrieving configuration information from the user. When the configuration dialog box 700 is created and displayed, a user populates the dialog box 700 with appropriate information and clicks OK 702. The administrative console GUI 216 then further populates the SMDNode instance 214 with the data received by the user via the dialog box 700. The administrative console 212 uses the fully populated SMDNode instance 214 to create 603 a new instance of HealthNodeImpl 356 based upon the SMDNode instance 214. The administrative console GUI 216 sends 604 an add event to the service model manager 206 with the HealthNodeImpl instance 356 as the argument. The service model manager 206 then processes the add event 606 for the HealthNodeImpl instance 356.

The administrative console 212 defines an SMExporter interface. The SMExporter interface defines the following methods for use within the service model manager 206:
public boolean handles(Object description);
public void add(ModelNode added);
public void remove(ModelNode removed);
public void export(File out) throws IOException;
public void start( );
public void terminate( );

The SMExporter interface is used by the service model manager 206 to alert registered SMExporter instances of different events, including node add and node remove events. Updating a node in the active service model 208 involves a node remove event followed by a node add event. Advantageously, in a specific embodiment, the SMExporter interface already defined in the conventional service model is sufficient for add and remove events as well as an update event. A class called CNSExporter, which is not part of the conventional service model, implements the SMExporter interface, which is part of the conventional service model. The CNSExporter class specifically defines the actions taken when any of the calls defined in the SMExporter interface are invoked for the CNSExporter class. The CNSExporter class is defined specifically for the network application 100 and, therefore, provides a hook into the conventional service model that permits use of the service model user interface to a new network application 100. The add( ) and remove( ) methods defined in the CNSExporter class, therefore, contain specific process steps that include writing XML streams using a TIBCO messaging bus with appropriate syntax for configuration of the CNS Performance Engine network application 100. Use of the TIBCO bus is a conventional communication process for communicating with the CNS Performance Engine network application 100. In addition, the CNS Performance Engine network application 100 also responds with an acknowledgment message over the TIBCO bus validating that the configuration request was successful. The add( ) and remove( ) methods are also written to receive the responsive XML stream from the CNS Performance Engine and report back if an error was seen as a result of performance of the add( ) or remove( ) methods.

The handles( ) method is called by the service model manager 206 to determine whether or not the CNSExporter instance is applicable to the HealthNodeImpl instance 356 that generates the requested event. If the handles( ) method reports that the CNSExporter instance is applicable to the HealthNodeImpl instance 356, then the method associated with the event is called. If the handles( ) method reports that the CNSExporter interface is not applicable to the HealthNodeImpl instance 356, then the event is ignored with respect to the CNSExporter.

Within the administrative console 212, there is a SMExporterFactory thread instantiated at start-up and available to the service model manager 206. Within the HealthNodeImpl class, there is an attribute with a value of the class that handles this type of node. The value indicates the JAVA package name and the class name. In the specific example, the JAVA package and class name points to the CNSExporter class. The service model manager 206 calls 605 the SMExporterFactory passing to it, the HealthNodeImpl instance 356. The SMExporterFactory reads the attribute value within the HealthNodeImpl instance 356 and creates a CNSExporter instance based upon the data found in the HealthNodeImpl instance 356. After the SMExporterFactory instantiates 606 the CNSExporter instance the SMExporterFactory sends it to the service model manager 206. The service model manager 206 calls handles( ) on the CNSExporter instance to see if the requested event is applicable to the HealthNodeImpl class and if so, calls add( ) 607 passing the HealthNodeImpl instance 356 as an argument.

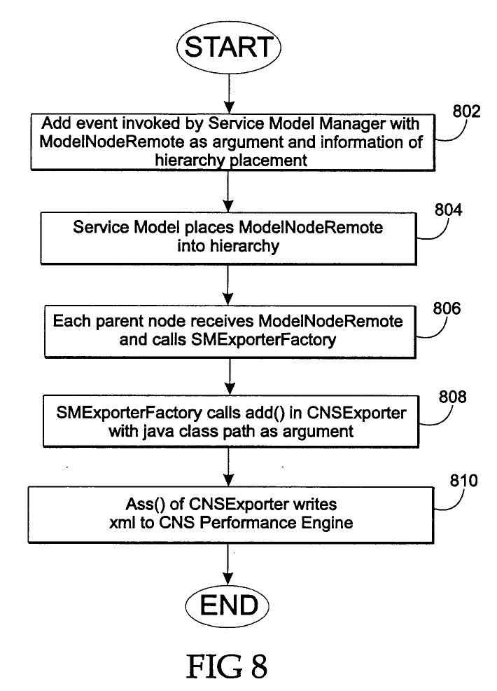

With specific reference to FIG. 8 of the drawings, there is shown a flow chart of the add operation performed by the service model manager 206 as part 607 of node instantiation into the active service model 208. The service model manager 206 initiates 802 the add operation 606 with the HealthNodeImpl instance 356 as an argument. When the add request is made of the service model manager 206 by the administrative console GUI 216, the service model manager 206 performs the add( ) event. The administrative console GUI 216 indicates in its add request to the service model manager 206, where to put the referenced node. The service model manager 206 receives the add( ) event and places the HealthNodeImpl instance 356 into the appropriate level in the active service model 208. The add( ) event is propagated 806 up the active service model hierarchy passing the HealthNodeImpl instance 356 as the argument. Each node receives the add event for processing. As each node of the active service model 208 recognizes the add( ) event, the add( ) event causes the CNSExporter instance associated with the added HealthNodeImpl instance 356 to be created. The SMExporterFactory examines the HealthNodeImpl instance 356 and checks it for one or more SMExporter attributes. If the SMExporterFactory identifies an SMExporter attribute in the HealthNodeImpl instance 356, the SMExporterFactory examines the attribute value associated with the identified attribute. The identified attribute value is a JAVA dotted class path. The SMExporterFactory then instantiates the specified class that implements the SMExporter interface, which is the CNSExporter class. The SMExporterFactory calls the handles( ) method within the CNSExporter class passing it the HealthNodeImpl instance 356 to determine if the HealthNodeImpl instance 356 is a type of node that is handled by the add( ) method. If the node is handled, the service model manager 208 calls 808 the add( ) method defined in the CNSExporter class and the node as defined in the HealthNodeImpl instance 356 is fully added to the Active Service Model tree 208 as a new instance. If the node is not handled, the HealthNodeImpl instance 356 is added, but not further processed by the add( ) method. The add( ) method as defined in CNSExporter traverses the HealthNodeImpl instance 356 to build the XML string to appropriately configure the network application 100 as requested by the user. The add( ) method then writes 810 the XML string to the network application 100.

The remove( ) method behaves in a similar manner when a node is deleted from the active service model 208. The difference is in the add( ) and remove( ) methods and the processes defined in the respective methods for the CNSExporter. The handles( ) method is used to determine if the HealthNodeImpl instance 356 is applicable to the requested event. If so, the remove( ) method is called and if not, it is ignored.

In addition to configuring CNS Performance Engine configuration components, the user can also configure CNS Performance Engine data collector components. The data collector components access those CNS Performance Engine functions that collect and report data. As part of the drag&drop instantiation process, the data collector is configured to collect and report data, but a user must choose to activate or deactivate the data collector before data collection is initiated. In a specific embodiment of the CNS Performance Engine network application 100, the activate and deactivate actions are implemented by using the “monitor” and “unmonitor” operations that have interfaces already defined in the conventional service model. The CNSExporter node re-maps the monitor/unmonitor operation for specific application to the CNS Performance Engine network application 100. The monitor/unmonitor operation is available from a right click pop-up menu in the administrative console GUI 216. The monitor/unmonitor operation is supported only on a subset of all defined CNS Performance Engine components that are defined as data collectors. The monitor/unmonitor operation serves to activate or deactivate, respectively, the referenced node in the system. The monitor/unmonitor operation is implemented in an SMTreeListener interface. The SMTreeListener interface defines the following methods:
public void nodeAdded(SmTreeEvent evt) throws RemoteException;
public void nodeRemoved(SmTreeEvent evt) throws RemoteException;
public void nodeChanged(SmTreeEvent evt) throws RemoteException;
public void guiAttrChange(SmTreeEvent evt) throws RemoteException;

In the specific embodiment of the CNS Performance Engine, the SMTreeListener interface is also implemented in the CNSExporter class. Accordingly, additional methods are further defined with the CNSExporter class. Specifically, the nodeChanged( ) method is remapped for purposes of the CNSExporter class and is implemented such that when a node is Monitored or Unmonitored an appropriate XML message is created and is sent to the CNS Performance Engine network application 100. For purposes of the CNS Performance Engine, the monitor/unmonitor operation performs a toggle. That is to say that if the nodeChanged( ) method is called, it acts to change the current state of the node and deactivate an active node and activate a deactive node. The SMTreeListener interface is implemented by the CNSExporter class to contain all of the information required to start and stop the CNS Performance Engine application components. The nodeAdded( ), nodeRemoved( ), and guiAttrChange( ) methods are also defined in the SMTreeListner interface, but are not used in the CNSExporter class. In the specific example, this is because SMExporter's add( ) and remove( ) methods are already defined in the SMExporter interface and the other methods that are part of the SMTreeListner interface are not used. Accordingly, for purposes of the CNSExporter class, all methods except the nodeChanged( ) method are defined as an empty implementation.

The teachings thus far disclosed describe an implementation wherein only a single application configures the network application 100. It is possible, however, to have an administrative console 212 communicating with the network application 100 and also to have the conventional XML message based user interface communicating with the same network application simultaneously. Such a scenario creates a synchronization issue where the user interface may not accurately reflect the state of the network application. The teachings that follow are for adaptations to the service model when the network application 100 may be configured by more that one external application, but the user interface can still accurately reflect a configured state of the network application.

Conventionally, the CNS Performance Engine network application 100 does not provide notice that an update to the network application 100 is made. If the conventional GUI and the service model GUI according to the present teachings are operating simultaneously, it is possible that the services pane portion 502 of the administrative console GUI 216 does not accurately reflect a configuration status of the network application 100 at all times. It is desirable, to provide a user interface to the network application 100 that is able to accurately reflect a status of the network application at all times without modification to the network application 100, and so a further adaptation of the service model is appropriate. It is only appropriate, however, to provide such a capability when the network application 100 can be configured through a means other than a single administrative console 212.

It is possible to update the administrative console with the current network application 100 status using a “Begin Discovery . . . ” command. “Begin Discovery . . . ” is available in the conventional service model interface as a right click from the services pane of the administrative console GUI 216 and may be applied to either a CNSPerfE-Configuration node 514 or a CNSPerfE-Datacollections node 516 within the active service model.

The children nodes of the CNSPerfE-Configuration node 514 represent nodes that configure the network application 100, but do not report data from the network application 100. A “Begin Discovery . . . ” event on a CNSPerfE-Configuration node 514, therefore, operates only to update a configuration status in the event that another tool with access to the network application 100 has changed the configuration of network application 100 and the user desires that the services pane 502 of the administrative console GUI 216 accurately reflects the current status of the network application 100. The process for updating the active service model is similar in function to the initialization of the administrative console 212 at start up. When a user initiates “Begin Discovery . . . ” on the CNSPerfE-Configuration node 514, the PerfEDisco class 302 is called on that node and thereby, operates on all children nodes of the CNSPerfE-Configuration node 514. The PerfEDisco class 302 sends an XML message 306 requesting the configuration status from the network application and receives the responsive XML file 202 containing the requested information. Using the component discovery XSLT file 308 and the service model templates 210, the PerfEDisco class 302 parses the responsive XML message 202 and creates the file based discovery file 204. The script file wrapper engine 350 reads the file based discovery file 204 and creates one or more discovered instances 304. The service model manager 206 receives the discovered instances 304 and updates the active service model 208 with a new HealthNodeImpl instances 356. At this point, the active service model 208 is accurate and the administrative console GUI 216 accurately reflects the network application configuration as of the time of the “Begin Discovery . . . ” event.

The CNSPerfE-Configuration node 514 represents a network application configuration portion of the active service model 208. All child nodes to the CNSPerfE-Configuration node 514 represent a fixed configuration state for the CNS performance engine network application 100. Accordingly, the “Begin Discovery . . . ” sufficiently updates the configuration nodes so that the administrative console GUI 216 reflects an accurate current status of the network application unless and until something other than the administrative console GUI 216 reconfigures that portion of the CNS Performance Engine network application 100. Selecting “Begin Discovery . . . ” initiates the PerfEDisco class 302 that acts on the node selected. The PerfEDisco class 302 is the same method regardless of how it is instantiated, but the node that initiates the event dictates a unique XSLT file used in the process. In all cases, a result of the PerfEDisco class 302 is a SmartFrog discovered instance 304 that is read by the service model manager 206 to populate the active service model 208 with the current network application configuration. The discovered instance 304, therefore, is no different from the conventional discovered instance 304 except that it is built using information from a network application 100 that is external to the service model environment.

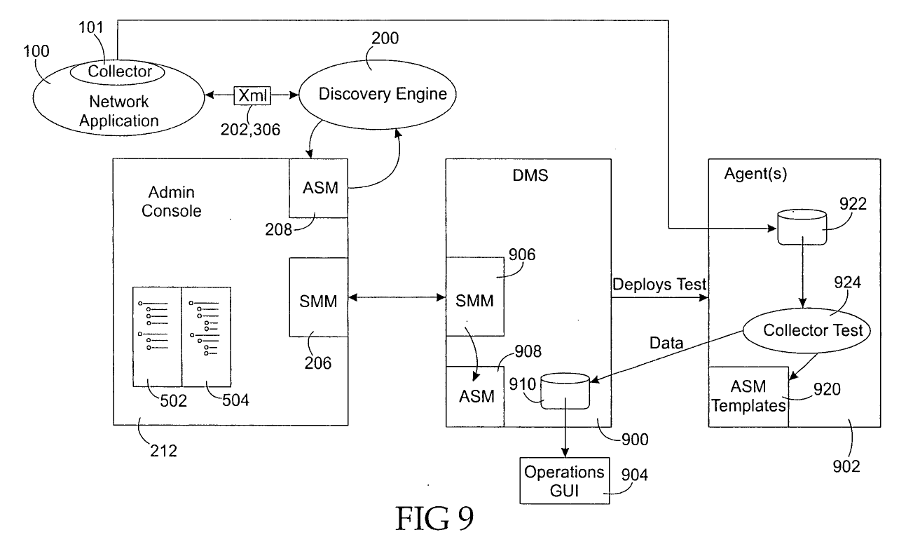

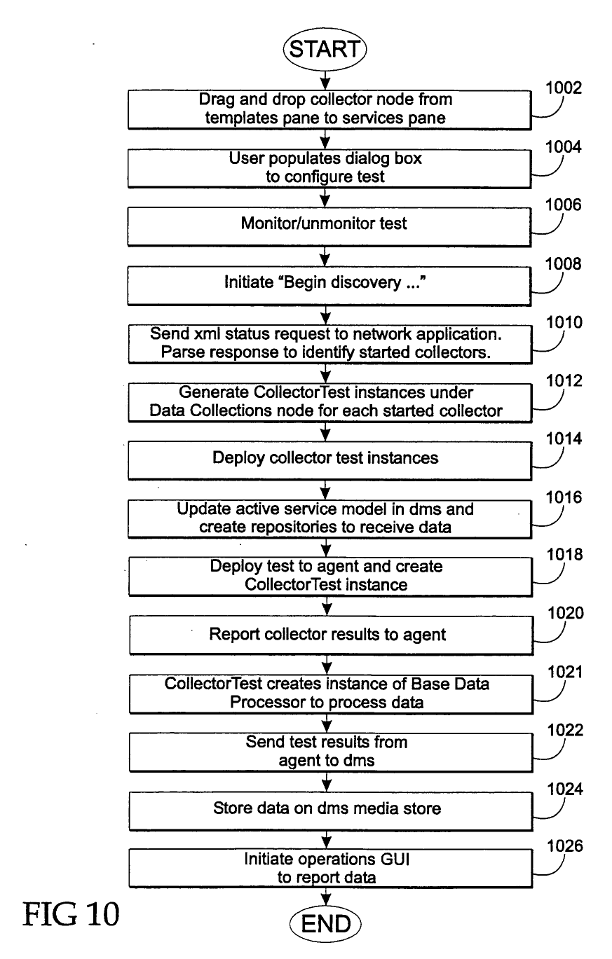

In a specific embodiment of the network application 100, there is a capability to make network measurements. As such, it is desirable for data from the network application 100 to be displayed to the user in a format that is integrated with the user interface of the conventional service model. The configuration of network application components as described herein only configures the network application 100. As such, only the administrative console 212 portion of the conventional service model is adapted for the purposes of integrating an external network application 100. In order to integrate measurements made by the network application 100 into the service model, and with specific reference to FIGS. 9 and 10 of the drawings, there is shown the administrative console 212 that accesses the Discovery Engine 200 to communicate with the network application 100 as previously disclosed. Reference is further made to a Data Management System (herein “DMS”) 900, one or more agents 902, and an operations graphical user interface (herein “operations GUI”) 904. The DMS 900 further comprises a DMS service model manager 906 that works in conjunction with the service model manager 206 that has already been described as part of the administrative console 212. The DMS 900 also maintains a copy of the active service model, or DMS ASM 908, that represents the currently configured network application 100. The DMS 900 further has access to a solid database on DMS media store 910. The one or more agent(s) 902 also maintains a local copy of the active service model templates, or agent ASM templates 920. The agent(s) 902 further has access to an agent media store 922. The agent media store 922 is used to receive and hold data produced by the network application. The data is stored on the agent media store 922 until a CollectorTest instance, which is part of an adaptation made to the agent(s) 902, is able to access the data and format the data into measurement information in a format consistent with a conventional format used by the DMS 900 for eventual delivery of the measurement information to the DMS 900. The operations GUI 904 is initiated by a user and is able to retrieve data from the solid database 910 maintained by the DMS 900 for reporting data to the user.

The administrative console 212, DMS 900, one or more agents 902 and operations GUI 904 are separate and independent programs that may or may not run on the same host processor. It is only necessary that each program is able to communicate with the other programs as disclosed herein. If they run on the same host processor, each program may or may not access the same physical storage media. One of ordinary skill in the art appreciates that even if the storage media is the same, the data store is kept as a separate entity in different files or different portions of files.

A data collection portion of the service model includes additional functions for retrieval and display of measurements made by the network application 100. Functions that are part of the network application that make measurements and report the data are referred to as “collectors” 101. With specific reference to FIG. 5 of the drawings, one or more of the leaf nodes displayed in the templates pane 502 are collector template nodes 508. An instance of the collector template node placed in the services pane 504 is called a “collector instance”. In order to configure a collector 101 on the network application 100, a user drag&drops 1002 one of the collector template nodes 508 to the services pane 504 and places it under the collectors tree node 518. The collectors tree node 518 is only able to properly receive collector instances. As previously described with respect to the component configuration, the drag&drop operation pops a dialog box similar to the one illustrated in FIG. 7 of the drawings, but specific to the type of node selected from the templates pane 502 for the user to populate 1004 according to desired characteristics of a desired test that is to be performed by the network application 100. An ftpDataHandler is also configured automatically for each collector instance. The ftpDataHandler configures the collector 101 on the network application 100 to store its data to a specific location. To start the collector 101, the user right clicks 1006 individual collector instances in the services pane 504 and selects a monitor/unmonitor toggle operation. If the collector 101 is not already started, clicking monitor/unmonitor starts it. If the collector 101 is already started, clicking the monitor/unmonitor stops the collector 101. The user then right clicks a Data Collections node 516 in the services pane 504 to access the “Begin Discovery . . . ” process. The “Begin Discovery . . . ” process initiates 1008 the discovery engine 200 and through the PerfEDisco class 302 sends an XML message 306 comprising a status request to the network application 100. The network application 100 responds with the responsive XML message 202. The PerfEDisco class 302 uses a data collection discovery XSLT file 310 to parse the responsive XML message 202 to identify 1010 collectors 101 that are started on the network application 100. For all identified collectors 101, the PerfEDisco class 302 writes pertinent collector information in the file based discovery file 204. The script file wrapper engine 350 accesses the file based discovery file 204 and creates 1012 new collector instances under the CNSPerfE-DataCollections node 516 in the active service model 208 to represent each one of the started network application collectors 101. Each collector instance in the active service model 208 under the DataCollections node 516, therefore, represents one of the collectors 101. During file based discovery, the instantiation process is repeated until all collectors 101 that are represented in the file based discovery file 204 are instantiated in the active service model 208 under the DataCollections node 516.

When the DataCollections node 516 is fully populated with all of the discovered started collector instances, the user deploys 1014 the collectors instances to the agent(s) 902 by selecting “Commit Changes” from the File menu in the administrative console 212. When the “Commit Changes” selection is made, the service model manager 206 operates in conjunction with the DMS service model manager 906 to update 1016 the DMS active service model 908, so that all nodes, including the new collector instances represented in the active service model 208, are instantiated in the DMS active service model 908. Upon identification of updates in the DMS active service model 908, the DMS service model manager 906 then creates new repositories in the solid database 910 that are able to receive data for each collector instance identified in the DMS active service model 908. The DMS 900, then deploys 1018 CollectorTest instances for each collector instance represented in the DMS active service model 908 to an appropriate agent 902. When it deploys each CollectorTest instance, the DMS 900 accesses the dms active eservice model 908 and sends a CollectorTest TestType and CollectorTest target for each collector instance to the agent 902. The agent(s) 902 uses the CollectorTest TestTypeattribute and CollectorTest target to look up whichTestto create. The agent(s) 902 references an agent copy of the active service model templates 920 and retrieves the test description associated with the CollectorTest TestType. The agent(s) 902 examines the CollectorTest description and accesses an sfClass attribute. In the specific example of the collector instance, the sfClass attribute indicates to the agent(s) 902 that a new CollectorTest class 924 is to be instantiated. If the collector instance target already exists, no action is taken. If the collector instance target does not exist, a new CollectorTest is instantiated for that collector instance target.

A BaseTest class is part of the conventional service model within each agent 902. The CollectorTest class extends the BaseTest class and is used for purposes of creating measurements from the data that is generated by the collectors 101 running on the network application 100. Base functionality of the CollectorTest class is maintenance of information as to where the collector data is stored, initiation of a BaseDataProcessor class, and delivery of test results to the DMS 900, specifically the solid database 910. All test classes within the agent(s) 902 that are not CollectorTests also extend the BaseTest class, but are different from the CollectorTest class. Accordingly, in a specific embodiment, only collectors 101 in the network application 100 have corresponding instances of the CollectorTest class in the agent(s) 902.

Within the CollectorTest instance Target is a reference to a BaseDataProcessor variable that refers to the instance of the BaseDataProcessor class. The BaseDataProcessor class includes intelligence as to how to create measurements from data returned by a specific type of collector 101 that is available within the network application 100. It is the BaseDataProcessor variable, therefore, that indicates the specific type of collector data that the CollectorTest instance can process. Examples of available BaseDataProcessors comprise measurements of jitter, udp echo, MIB, and icmp echo. The agent(s) 902 schedules the new instance of the CollectorTest 924 when the test begins. The CollectorTEst 924 instance accesses the CollectorTest Target and identifies an fhCollector Name attribute value. The CollectorTest 924 instance instantiates an instance of the class specified by the fhCollector Name and assigns it to the BaseDataProcessor variable contained within the CollectorTest 924 instance. The BaseDataProcessor extracts the appropriate data from a file on agent media store 922 and returns the data to the CollectorTest 924 instance in a format that is understood by the dms 900.

As a started collector 101 generate data, The Collector 101 it delivers the data directly to the agent media store 922 using file transfer protocol (“ftp”). The CollectorTest instance 924 on the agent 902 contains information that identifies where the new data is stored on the agent local disk 922 for its respective collector 101. The CollectorTest instance formats measurement data for the dms 900 from the new data located on the agent local disk 922, using the BaseDataProcessor that was specified in the CollectorTest target. The formatted measurement data is then sent 1022 to the dms 900. The dms 900 stores 1024 the measurement data in the solid database on the dms local disk 910. All measurements reported by the collectors 101 through the one or more agent(s) are, therefore, collected within the solid database on the dms local disk 910. To view the measurement data 1026, a user initiates the operations GUI 904. The operations GUI 904 first retrieves the measurement data stored on the dms local disk 910, formats it for presentation, and then reports it to the user.

In one embodiment, the active service model 208 is updated only when the user initiates the “Begin Discovery . . . ” command. In another embodiment, the PerfEDisco class 302 may be scheduled to occur at regular intervals that may be established by a user. The selection of when and how the PerfEDisco class 302 is initiated may also be available as a selectable option within the network application 100 or as part of the network application configuration use interface.

Embodiments of a method according to the present teachings are herein disclosed for purposes of illustration and are not meant to limit that which is claimed. Many alternatives not specifically illustrated will occur to one of ordinary skill in the art with benefit of the present teachings. Those many alternatives remain within the scope of the appended claims. As a specific example, when receiving the responsive XML string 202 from the network application and rather than using the XSLT files, the XML data may be parsed with JAVA classes specifically implemented to translate the XML data to the file based discovery file.

1. A method of programming a network application comprising:
Representing available functions of the network application as at least one template node in a templates pane and configured functions of the network application as at least one services node in a services pane,
Selecting one of said template nodes,
Presenting a dialog box associated with said template node,
Populating said dialog box with configuration data, and
Configuring said network application according to said configuration data.

2. A method of programming as recited in claim 1 said step of representing further comprising representing said template nodes in a hierarchical display.

3. A method of programming as recited in claim 2 said step of representing further comprising representing said services nodes in a hierarchical display.

4. A method of configuring as recited in claim 1 wherein said steps of selecting, populating and further comprises dragging and dropping said template node from said templates pane into said services pane.

5. A method of programming as recited in claim 4 wherein said step of dragging and dropping initiates said step of displaying said dialog box.

6. A method of programming as recited in claim 1 wherein at least one of said available functions represents a data measurement function of said network application.

7. A method of programming as recited in claim 6 and further comprising the step of starting said data measurement function as a step that is separate from said step of configuring.

8. A method of programming as recited in claim 7 wherein said network application operates on a host and said data measurement function reports data to an agent.

9. A method of programming as recited in claim 8 wherein said host and said agent operate on a single processor.

10. A method of programming as recited in claim 8 wherein said agent formats said data into measurement data and sends said measurement data to a data management system.

11. A method of programming as recited in claim 10 and further comprising the steps of retrieving said measurement data from said data management system and reporting said measurement data.

12. A method of programming as recited in claim 8 wherein said host and said agent operate on different processors of a communication network.

13. An apparatus for programming a network application comprising:
A processor in communication with said network application,
means for representing available functions of the network application as at least one template node in a templates pane and configured functions of the network application as at least one services node in a services pane,
Means for Selecting one of said template nodes,
Means for Presenting a dialog box associated with said template node,
Means for Populating said dialog box with configuration data, and
Means for Configuring said network application according to said configuration data.

14. An apparatus as recited in claim 13 said means for representing further comprising means for representing said template nodes in a hierarchical display.

15. An apparatus as recited in claim 14 said means for representing further comprising means for representing said services nodes in a hierarchical display.

16. An apparatus as recited in claim 13 wherein said means for selecting and populating further comprises means for allowing a user to drag and drop said template node from said templates pane into said services pane.

17. An apparatus as recited in claim 13 wherein at least one of said available functions represents a data measurement function of said network application.

18. An apparatus as recited in claim 17 wherein said network application operates on a host processor and said data measurement function reports data to an agent.

19. An apparatus as recited in claim 18 wherein said host and said agent operate on a single processor.

20. An apparatus as recited in claim 18 wherein said host and said agent operate on different processors that are part of a communication network.

21. An apparatus as recited in claim 18 wherein said agent formats said data into measurement data and sends said measurement data to a data management system.

22. An apparatus as recited in claim 21 and further comprising means for retrieving said measurement data from said data management system and reporting said measurement data.

23. A method for generating a user interface for configuration of a network application comprising the steps of:
Providing a template driven service model having a user interface and a first node class having a first node interface instantiated when a node is configured,
Determining configurable properties of said network application,
Generating a template readable by said network services model describing said configurable properties for said user interface,
Executing said service model on a processor,
Making said template available to said service model,
Defining a second node unique to said network application that implements said first node interface and
Remapping said first node interface for said second node to a process unique to said network application.

24. A method as recited in claim 2 and further comprising the steps of requesting a configuration status from said network application and translating a response from said network application into a form readable by said service model.

25. A method as recited in claim 2 wherein said user interface comprises a templates pane for displaying configurable components of said network application.

26. A method as recited in claim 25 wherein said user interface further comprises a services pane for displaying configured instances of said components of said network application.

27. A method as recited in claim 26 wherein the step of configuring comprises the steps of dragging a dropping an icon that represents a configurable component from said templates pane into said services pane.

28. A method as recited in claim 27 wherein said step of dropping invokes a dialog box to configure said configurable component that is represented by said icon.

29. A method as recited in claim 2 wherein said network application comprises a CNS Performance Engine.

30. A method as recited in claim 2 wherein said network application is configurable by more than one user interface.

31. A method for integrating a network application into a template driven service model comprising the steps of:
Establishing configurable properties of the network application,
Selecting existing interfaces in the template driven service model consistent with said configurable properties,
Instantiating specialized nodes that implement said existing interfaces,
Remapping methods of said specialized nodes to operations unique to the network application, and
Configuring the network application through said specialized nodes.

32. A method as recited in claim 32 wherein said specialized nodes contain definitions for said operations unique to the network application.
